(19) United States
(12) Patent Application Publication
(10) Pub. No.: US 2017/0270630 A1
(43) Pub. Date: Sep. 21, 2017

(54) WATERMARKING SYSTEM AND METHOD

(71) Applicant: PHILIPS LIGHTING HOLDING B.V., EINDHOVEN (NL)

(72) Inventors: MARTINUS PETRUS CREUSEN, WIJLRE (NL); RALPH KURT, EINDHOVEN (NL); FREDERIK JAN DE BRUIJN, EINDHOVEN (NL)

(21) Appl. No.: 15/505,709

(22) PCT Filed: Aug. 20, 2015
(86) PCT No.: PCT/EP2015/069188

§ 371 Date: Feb. 22, 2017

(30) Foreign Application Priority Data
Aug. 22, 2014 (EP) 14181890.6

(51) Int. Cl. G06T 1/00; G06F 21/16; G06F 17/30; H04N 5/225; H04N 7/18

(52) U.S. Cl. CPC G06T 1/005; H04N 5/2256; H04N 7/183; G06F 17/30867; G06F 21/16; G06T 2201/0063; G06F 2221/0737

(57) ABSTRACT

A device comprises an image handling module for protecting an image of a scene captured by a camera. The image handling module is configured detect, in association with the image, a watermark signal having been embedded in light illuminating the scene at a respective geographic location. Further, the image handling module is configured to lookup the detected watermark signal in a privacy database, and based thereon to selectively inhibit use of the image.

### TECHNICAL FIELD

The present disclosure relates to embedding a watermark signal in light illuminating a scene, so that the watermark appears in any image of the scene captured by a camera.

### BACKGROUND

A watermark is a signal embedded in a document or medium that can be taken as an indication of origin. Historically a watermark referred to a faint logo or pattern in a paper document that becomes visible when the paper is held up to the light. Nowadays a watermark may also refer to a signal embedded into other types of document or medium, such as an electronic image or audio recording, typically in manner that is hidden or at least unobtrusive relative to the main content of the document or medium in question.

In the case of an image taken by a camera, conventionally the watermark is added to the image electronically after it has been captured. However, this only protects a specific image and copies thereof, not the subject matter of the image itself.

WO 2002/35850 on the other hand, describes a system in which a watermark signal is embedded in the light illuminating a scene such as a live concert, a soccer match or an exhibition of a painting, thereby ensuring that any image taken of the scene will contain the watermark. The technique is designed to enable forensic tracking to discourage the unauthorized taking of photographs, and to allow unauthorized photographs to be identified.

### SUMMARY

According to one aspect of the present disclosure, there is provided a device comprising an image handling module for protecting an image of a scene captured by a camera. The device may comprise the camera, with the image handling module being incorporated into the same unit as the camera (e.g. a dedicated camera unit or a user terminal such as a smartphone or tablet). Alternatively the device in which the image handling module is implemented may be separate from the camera, being a separate unit having an interface for receiving the image from the camera. For example, the separate device could be a user device (e.g. a separate user terminal such as a desktop or laptop computer, or a dedicated storage unit such as an external hard drive); or as another example the separate device may comprise a server (formed of one or more server units at one or more sites).

Wherever implemented, the image handling module comprises a watermark detector configured to detect, in association with the image, a watermark signal having been embedded in light illuminating the scene at a respective geographic location. In embodiments the watermark is detected from the captured image itself. Further, the image handling module comprises a privacy filter configured to look up the detected watermark signal in a privacy database, and based thereon to selectively inhibit use of the image.

According to another aspect disclosed herein, there is provided a system comprising: a plurality of light sources each arranged to illuminate a respective scene at a respective geographic location; and one or more controllers arranged to embed a respective watermark signal in the illumination from each of said light sources. The system further comprises the privacy database, and a device comprising an image handling module, again being configured detect the respective watermark signal from an image of one of said scenes captured by a camera, to look up the detected watermark signal in the privacy database, and based thereon to selectively inhibit use of the image.

For example, the privacy setting may prevent the camera from storing the image on any local storage, and/or may prevent the camera from sharing the image with any other, external device. As another example, the privacy setting may prevent the image from being shared over the Internet, or uploaded to one or more social media sites.

The privacy settings in the database may be implemented in a number of ways. In embodiments, the protection is dependent on whether the watermark is registered in the database. In this case, the selective inhibiting comprises inhibiting use of the image on condition that a privacy setting for the detected watermark is found in the database. I.e. if an entry for a particular scene is not present in the database, the scene is not protected. Alternatively, the privacy database may map a respective privacy setting to each of a plurality of watermark signals embedded in light illuminating respective scenes at different respective geographic locations. In this case, each of the privacy settings in the database may specify one of at least two possible classification levels, comprising an unprotected level defining the scene as having no privacy protection, and at least one privacy protected level defining the scene has having at least a degree of privacy. I.e. there is an entry in the database for each scene (or at least some of the scenes), recording whether or not that scene is protected (so some scenes are explicitly marked as unprotected). In this case, the selective inhibiting may comprise inhibiting use of the image on condition that the privacy setting for the detected watermark specifies a privacy protected level.

The database may just determine whether the scene is protected on a yes/no basis, or alternatively the database may support different levels of privacy protection. Hence in embodiments, each of the privacy settings in the database may specify one of two or more possible classification levels, these comprising a plurality of privacy protected levels each defining the scene as having a different degree of privacy; and said selective inhibiting may comprise inhibiting an extent of the use of said image in accordance with the classification level mapped to the detected watermark.

For instance, at least some of the privacy protected levels may correspond to different categories of user being authorized to use the image, and said selective inhibiting may comprise preventing at least one type of use of the image by users other than those authorized according to the classification level mapped the detected watermark. Alternatively or additionally, at least some of the privacy protected levels may correspond to different types of use being allowed, and said selective inhibiting may comprise preventing the type of use disallowed according to the classification level mapped the detected watermark. Further, at least some of the privacy protected levels may specify different combinations of which types of use are to be prevented for different categories of user.

For example, the privacy levels could include: a highly classified level for areas such as military or government facilities where no photos are allowed; a medium privacy level for, say, confidential company meetings and/or research facilities where photos can only be taken and/or distributed by authorized personnel; and/or a low privacy level where anyone can take a photo but only certain authorized users can make the photos available to others through certain channels (e.g. only friends can upload to social media).

The privacy database may be implemented as a dedicated privacy database mapping watermarks directly to privacy settings. Alternatively the privacy database may be implemented using two or more constituent databases, whereby one constituent database maps the watermarks to some other property and a second constituent database maps that property to the respective privacy setting. For example, the privacy database may be based on a location database, which may be pre-existing for some other reason or compiled for the purpose of privacy. In this case the location database maps the watermark to an indication of the geographic location of the respective scene illuminated by the watermarked light, and the second constituent database maps the geographic location to the respective privacy setting.

Furthermore, in embodiments one or more of the privacy settings in the database may be a function of time, such that different values for the privacy setting (e.g. whether protected or unprotected, or different levels of protection) can be specified for different times of day.

In further embodiments, the device may be configured to receive a complementary code via a medium other than embedding information in light received by the camera. The privacy filter may be configured to then use the complementary code to verify or decrypt the watermark, and to automatically inhibit the use of the image by default if the detected watermark is not successfully verified or decrypted respectively.

In yet further embodiments, the system may comprise a payment infrastructure for accepting a payment in relation to at least one of said geographic locations. Based on the payment, the payment system can then either: (i) enable a party having an interest in the at least one geographic location to register the respective watermark in the privacy database, and/or to select the respective privacy setting mapped to the respective watermark; or (ii) enable a party wishing to use an image of the at least one geographic location to receive the complementary code for verifying or decrypting the watermark.

As an example of (i), paying customers can be offered privacy for their location by arranging their lighting at the desired location to emit with an embedded watermark, and then registering with the database. E.g. an organizer of a concert can register the venue as protected and prevent unauthorized photos of the concert from be published (while in embodiments, say, still allowing concert goers to take photos for private use. Or as another example, a user such as a celebrity could illuminate his or her home or garden with watermarked illumination and pay to prevent unwanted photographs being taken on private occasions. As an example of (ii), a photographer or videographer could pay to receive a license to photograph an event or to record a video of the event (storing the image immediately after capture being one type of use that can be controlled).

The complementary code may be provided to the user in the form of a digital license. Such a license may be associated to that party, e.g. using a party identifier in the form of a physical token such that the license cannot be duplicated and/or may be associated to a device such that the license is specific to that device (e.g. using a device identifier). For example in the above camera example, the digital license itself may be encrypted with a device key available only to that camera.

According to another aspect disclosed herein, there is provided a method comprising:

illuminating a respective scene at each of a plurality of respective geographic locations; embedding a respective watermark signal in the illumination illuminating each of the respective scenes; keeping a privacy database registering at least some of the watermark signals; detecting the respective watermark signal in association with an image captured by a camera at one of said scenes; looking up the detected watermark signal in the privacy database; and based on said look up, selectively inhibiting use of the image.

In embodiments, the method may comprise receiving a payment in relation to at least one of said geographic locations, and in response either: (i) allowing a party having an interest in the at least one geographic location to register the respective watermark in the privacy database, and/or to select the respective privacy setting mapped to the respective watermark; or (ii) providing, to a party wishing to use the image, a complementary code for verifying or decrypting the watermark.

In further embodiments, the method may comprise further steps in accordance with any of the device, lighting controller and/or database features discussed herein.

According to a further aspect, there may be provided a computer program product embodied on at least one computer-readable storage medium, configured so as when executed on the device, lighting controller and/or a computer (e.g. server) hosting the privacy database, to perform operations of the device, controller and/or privacy database respectively in accordance with any embodiment disclosed herein.

### BRIEF DESCRIPTION OF THE DRAWINGS

To assist understanding of the present disclosure and to show how embodiments may be put into effect, reference is made by way of example to the accompanying drawings in which:

FIG. 1 is a schematic block diagram of a system for illuminating a scene and protecting images of the scene,

FIG. 2 is a schematic block diagram of an image handling module for protecting an image of a scene, and

FIG. 3 is a schematic block diagram of a system for illuminating a respective scene at each of a plurality of locations and protecting each of the scenes.

### DETAILED DESCRIPTION OF EMBODIMENTS

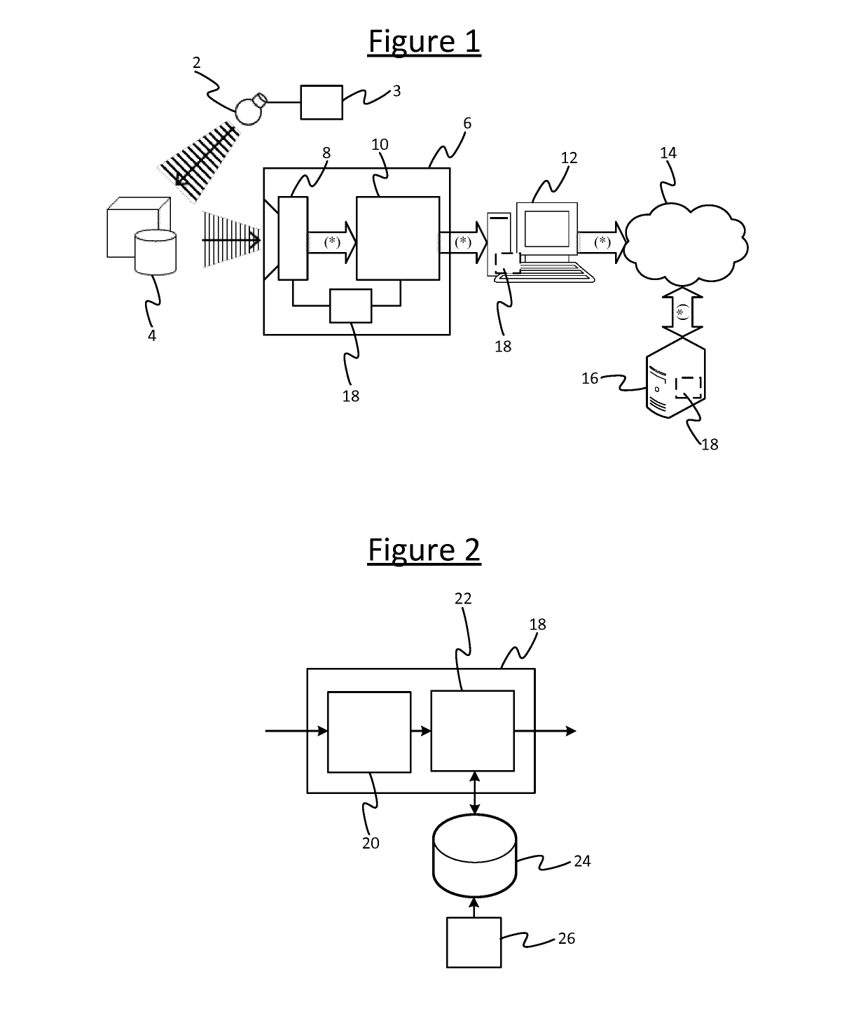

FIG. 1 illustrates a lighting system in accordance with embodiments of the present disclosure. The system comprises a light source 2 comprising one or more lighting elements (e.g. LEDs), arranged to illuminate a scene 4 comprising one or more living or inanimate objects that are considered private in that a person having an interest in those one or more objects desires to prevent or limit photographs and/or videos being taken of the one or more objects.

A camera device 6 comprising a camera 8 is also present in the system. The camera 8 has an aperture and an image sensor (not shown) comprising a two dimensional array of pixel sensors. The light source 2 is arranged such that the light it emits will be reflected from the one or more objects in the scene 4 through the aperture of the camera 8, thereby forming an image of the scene 4 on the image sensor of the camera 8. Thus the camera is able to capture an image of the scene 4. Note however that, while the pixel samples of the captured image may exist temporarily in the camera's logic in a volatile form (such as in latches, registers or RAM of the camera), the term “capture” as used herein does not in itself imply the image is necessarily stored by the camera 8, i.e. in any non-temporary (non-volatile form), not even in local storage. As will be discussed in more detail shortly, in some embodiments the system provides control over whether the camera 8 is allowed to store captured images in any local storage.

Note also that the camera 8 may be a camera for capturing still images and/or a video camera for capturing moving video images. Where an image is referred to herein, unless stated otherwise this may refer to either a still image (single frame) or video image (a sequence multiple frames).

The light from the light source 2 preferably takes the form of illumination for illuminating the scene 4 to make the one or more objects in the scene visible, e.g. room lighting, stage lighting or floodlighting. This light does not itself contain any visible image content for users, i.e. does not in itself project any still or moving image into the scene 4 for the benefit of being viewed by a user (unlike a movie projector for example). Rather, the light is shone onto the scene 4 such that when reflected from whatever one or more objects are present in the scene 4 then an image of that scene, including detail of the one or more objects, will be formed on the image sensor of any eye or camera 8 viewing that scene. For instance, in embodiments the light emitted by the light source 2 may be plain, monochromatic light such as substantially white light, or may be multi-colored stage lighting or ambient lighting designed for its aesthetic appearance but which nonetheless does not in itself convey any image content intended for a user (again unlike a movie projector).

Nonetheless, to facilitate the privacy of the scene, the system comprises a controller 3 connected to the light source 2 (locally or remotely by a wired or wireless connection), wherein the controller 3 is configured to embed a watermark signal into the light emitted by the light source 2. The watermark signal is a code embedded into the light, designed to be read electronically by an image handling module 18. As this code is embedded in the light illuminating the scene 4, this means it will be present in any image of the scene 4 captured by any camera 8 and any copy of such an image. Thus it can be ensured that the scene 4 itself is protected by the watermark, rather than just some individual images of the scene being watermarked.

Preferably the embedded watermark is invisible to the human eye in the illumination of the scene (e.g. does not cause a visible flicker), and invisible to the human eye in the captured image. Though in less preferred alternatives, the embedded watermark may simply be unobtrusive to a human. There are a number of suitable techniques for embedding a code into the illumination from a light source 2.

One option is to use coded light. According to coded light techniques, the intensity of the light emitted by the light source 2 is modulated at a frequency high enough to be invisible to the human eye (or at least tolerably so). In embodiments, the modulation may comprise a single tone (sinusoid) or a single oscillating waveform (e.g. rectangular wave) and the frequency of this tone or waveform acts as the embedded code (i.e. different light sources 2 each emit light with a different unique modulation frequency, unique within the system in question). Alternatively more complex modulation schemes are possible in order to embed more complex data. For example the modulation frequency may be varied to represent data according to a frequency keying scheme, or the phase of the modulation frequency may be varied to represent data according to a phase keying scheme, or the amplitude of the modulation may be varied to represent data according to an amplitude keying scheme (e.g. a Manchester code).

To detect coded light, in embodiments the camera 8 is a rolling-shutter camera 8 in which the pixels of the image sensor are grouped into a plurality of lines (e.g. horizontal rows), and the camera 8 captures an image by exposing each of the lines in a sequence, at slightly different successive times. Thus each line captures the light from the light source 2 at a slightly different time, and hence a different phase of the modulation. If the line rate is high enough relative to the modulation frequency, this therefore enables the modulation to be detected in the image. If the code is short enough relative to the number of lines in a frame, then the code can be detected in a single frame; or otherwise the code can be detected over multiple frames of a video image. Also, if the camera 8 is not a rolling shutter camera but rather a global shutter camera which exposes the whole frame at once, then the coded light can still be detected from a video image if the frame rate is high enough relative to the modulation frequency. Suitable coded light techniques will in themselves be familiar to a person skilled in the art.

In embodiments, controller 3 is configured to embed the same watermark in the light from a given light source 2 on two or more different modulation frequencies, either simultaneously or alternating between them, in order to ensure that the watermark is detectable by any or most cameras that might be present at the respective scene. A modulation frequency in coded light will be undetectable if it is an integer multiple of 1/Texp where Texp is the exposure time of the camera 8 (the line exposure time in the case of a rolling shutter camera or the frame exposure time in the case of a global shutter camera). As will be known to a person skilled in the art, these “blind spots” at n/Texp are due to a filtering effect in the camera's transfer function. However, if the same watermark is transmitted on two different modulation frequencies, preferably having an irrational relationship between them, then the watermark will always be detectable on one of the two modulation frequencies no matter what the exposure time of the camera 8. The controller 3 may be configured to alternate between the two or more modulation frequencies, or more preferably to emit the watermark on the two or more different modulation frequencies simultaneously.

As an alternative to coded light, another option is to code the watermark into the spectral composition of the light. For example, the light source 2 may comprise more than three different, individually-addressable light-emitting elements (e.g. LEDs) with different spectral content, such as different primary or phosphor converted colors. For example the light source 2 may comprise red, blue, green, white and amber LEDs. In this case, the light source 2 is configured to operate in at least two different states, which are each characterized by substantially the same color point, i.e. the same color appearance such as white or a specific pastel color on a white wall; but each of which states are nonetheless characterized by a different spectral composition, e.g. one comprises a significant red light component, whereas the other does not (or only very little).

The relative difference in the spectrum enables information to be embedded in the light by alternating or oscillating between the two or more different states, in a way such that an illuminated object of a certain color in the scene 4 will change its color appearance rapidly. E.g. a red object will appear to alternate from red to grey/brown and then back to red, while white parts of the scene stay white in appearance. The speed of altering between these two or more states is preferably above 100 Hz, more preferably above 150 Hz, and most preferably above 1 kHz (and the duration of both states may be set individually). Hence the alternation is at a high enough frequency to be not noticeable to a human, but can be detected electronically by comparing the apparent color of the non-white object in different frames. In embodiments this is done by comparing the intensity of a certain color component (e.g. by comparing the red component).

In one example, the light source 2 comprises red (R), blue (B), green (G), cold white (CW) and amber (A) LEDs. In order to achieve a certain target color point (e.g. warm white with a color temperature of 2700K), several settings of said multiple LED light sources are possible: e.g. using only R-G-B, or using all colors, or only using CW and A. There are various different combinations which all achieve the same white appearance on a white wall. However, the spectral content of each of these settings is different.

To improve detection, the spectral light intensity difference for the component being compared (e.g. red component) is preferably at least 30%, more preferably more than 50%, and most preferably more than 70% between the two alternating states.

By whatever means the watermark is implemented, it is detected by an image handling module 18 which is configured to selectively apply an associated privacy policy in dependence on the watermark. As shown in FIG. 1, the image handling module 18 may be implemented in one or more of a number of different possible places, such as: in the same unit as the camera device 8 (meaning integrated into the same housing); in an external device 12 (a device in a separate unit, i.e. separate housing, than the camera device 6); or a server 16 (comprising one or more server units at one or more sites, i.e. at one or more data centers or geographic locations).

Referring to FIG. 2, the image handling module 18 comprises a watermark detector 20 and a privacy filter 22. These may be implemented in software stored on one or more memories and arranged for execution on one or more processors of the relevant device, or may be implemented in dedicated hardware circuitry, or configurable or reconfigurable hardware circuitry (e.g. a PGA or FPGA), or any combination of such options.

The watermark detector 20 is configured to detect the watermark that was included in the light illuminating the captured scene 4, according to any one or more of the techniques discussed above (or indeed any other suitable light watermarking technique). The privacy filter 22 is configured to then look up the watermark in a privacy database 26. The privacy database 26 may be implemented wholly or partially in the same device 6, 12, 16 as the watermark detector 20 and/or privacy filter 22 (e.g. on the user device 6); and/or the privacy database 24 may be implemented wholly or partially in a separate, external device (e.g. separate server) in which case the privacy filter 22 is configured to access the database 24 over a network such as the Internet 14. Note also that the term “database” as used herein does not imply any specific size or data structure, and may refer to any suitable information source from a small look-up table to a large database.

In embodiments, the watermark detector 20 is configured to detect the watermark from the captured image of the scene 4 originating from the camera 8. I.e. the image being protected is also the same image from which the watermark is detected (e.g. detected from the modulation that appears invisibly in the lines of the image captured by a rolling-shutter camera). This has the advantage that the watermark continues to have is protective effect even if copies of the image are made. For example, if the privacy filter 22 is implemented in an external device 12 or server 16, the watermark may be detected from the recorded material received from the camera 8. Alternatively however, in the case where the watermark detector is implemented on the camera 8, it is not excluded that the watermark could be detected at another moment in time such as during shutter opening time, or that the watermark could even be detected using a separate sensor. For instance, when a still image is shot with a camera 8 such as that of a smart phone, the capturing device will be exposed to light on site for a longer time than merely the one “photo” frame that is captured as the image content. In this manner even a still camera can sense a coded light code that exceeds the length of one frame.

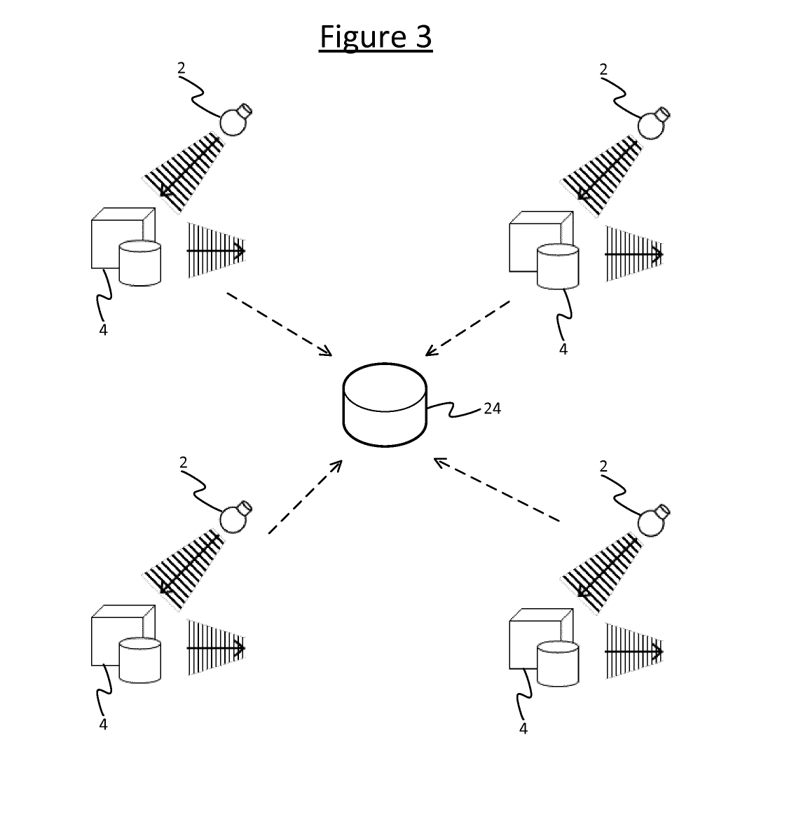

Referring to FIG. 3, the system comprises a plurality of different scenes 4 at a plurality of different geographic locations. Each scene 4 is illuminated by a different respective light source 2, each of which is controlled to emit light embedded with a different respective watermark, i.e. a different unique code that is unique to the scene at the respective location (unique within the watermarking scheme in question). Note, if a given scene 4 at a given location is illuminated by multiple watermarked light sources 2, then the different sources 2 at that location are preferably synchronized to emit with the same watermark with the same timing (i.e. synchronized modulation). This may be achieved either by a common controller 3 at the location in question, or by separate controllers 3 which negotiate between one another. Note also, the light sources 2 at the different locations may each be controlled to embed their respective watermarks by their own respective, separate controllers 3; or some or all of the light sources 2 at the different locations may be networked together and controlled by a common, central controller 3.

The privacy database 24 comprises a register of at least some of the watermarks (i.e. embedded codes) for the different respective locations. The privacy filter 22 is configured to access the database 24 (locally or remotely), to look up the detected watermark to determine whether and/or to what degree the respective scene 4 is privacy protected, and to inhibit or enable one or more uses of the captured image in dependence on the result of the look-up in the database 24. For example, the inhibited uses may comprise storage, distribution, and/or viewing of the captured image content. The inhibition may comprise a complete ban on the use in question, or allowing the use only by certain authorized users and/or at certain authorized times, or banning the use by certain prohibited users and/or at certain prohibited times.

In FIG. 1, the arrows marked (*) show examples of the various stages of data transfer which may be restricted depending on the privacy policy associated with the detected watermark.

In embodiments, an instance of the image handling module 18 is integrated into the same unit as the camera device 6, along with the camera 8 and any local storage 10 (any one or more non-volatile memories) of the camera device 6. For example the camera device 6 may take the form a dedicated camera unit, or a mobile user terminal such as a smart phone or tablet. In this case, the image handling module 18 may inhibit the camera device 6 from recording the watermarked image in local storage 10, transferring the image externally to another device 12, transferring the image over a network 14 (e.g. the Internet), and/or displaying the image on a local display of the camera unit 6, or doing one or more of these without authorization. Note that in the case where the camera device 6 can neither store the image locally, display it locally, nor transfer it to the any external device, this amounts to an instruction to immediately destroy the image upon capture (the strictest inhibition of use).

In embodiments, an instance of the image handling module 18 may alternatively or additionally be implemented in an external device 12. That is, a device external to the housing of the camera device 6. For example the external device 12 may be a user terminal such as a desktop or laptop computer, a tablet or a smartphone; or may be any other type of external device such as an external hard drive. In this case, even if the camera device 6 is operable to transfer a copy of the image to the external device 12 (by a wired or wireless connection, directly or over a network) then the further proliferation of the image may still be inhibited by the image handling module 18 on the external device 12. The watermark detector 20 detects the watermark still present in the copy of the image it received from the camera device 6. Based on this, the privacy filter 22 looks up the associated privacy setting in the privacy database 24, and acts accordingly. For example the external device 12 may be prevented from: storing the image in any of its own local storage (non-volatile memory), transferring onwards to any further external devices external to itself (i.e. in yet another housing), transferring the image over a network (e.g. the Internet), and/or displaying the image, or doing one or more of these without authorization.

In yet further embodiments, an instance of the image handling module 18 may alternatively or additionally be implemented in a server 16. Note that server here may refer to a logical server, i.e. so the server may be implemented in one or more server units (one or more server housings) at one or more sites (one or more data centers or geographic locations). If the server is distributed over one or more units and/or sites, it is distinguished from other servers in that it is operated by a given party. In the case of a server, the server 16 may be operable to receive a copy of the image from the camera device 6 over a network 14 such as the Internet, either directly or vicariously via another device 12 separate from the camera device 6 and server 16. The watermark detector 20 at the server 16 then detects the watermark still present in the copy of the image it received, and the privacy filter looks up the associated privacy filter and acts accordingly. For example, the watermark may prevent the server 16 from publishing the image on a social media site, or from making the image available over a network such as the Internet in any manner, or doing so without authorization.

It will be appreciated these are examples, and many other applications are also possible. As a broader (but not necessarily exhaustive) list of examples, the privacy setting may prevent the camera device 6, external device 12 and/or server 16 from doing one or more of the following:

a) recording the image on any local storage of said device,
b) sharing the image with any external device,
c) sharing the image with any external device except one or more authorized devices,
d) sharing the image with one or more prohibited devices,
e) sharing the image with any external device except one or more devices of one or more authorized users,
f) sharing the image with one or more external devices of one or more prohibited users,
g) sending the image over any network,
h) sending the image over any network except one or more authorized networks,
i) sending the image over one or more prohibited networks
j) sending the image to any network address other than one or more authorized addresses,
k) sending the image to one or more prohibited network addresses,
l) sending the image over the Internet,
m) publishing the image over the Internet,
n) uploading the image to any website,
o) uploading the image to any website except one or more authorized websites,
p) uploading the image to one or more prohibited websites,
q) uploading the image to any social media service,
r) uploading the image to any social media site except one or more authorized social media services,
s) uploading the image to one or more prohibited social media services,
t) accepting the image from any external device,
u) accepting the image from any external device except one or more authorized devices,
v) accepting the image from one or more prohibited devices,
w) accepting the image from the camera,
x) displaying the image,
y) making any copy of the image, and/or
z) publishing the image (i.e. make the image publically available by any means).

Note that inhibiting use of an image (e.g. preventing storage, transfer, display, or publication of an image) may refer herein to the whole image, or may refer any part of the image. So where it is said herein that an image is prevented from being stored, in embodiments this may mean only the whole image is prevented from being stored, or more preferably in embodiments it may mean that any part of the image content is prevented from being stored. Similarly, where it is said herein that an image is prevented from being transferred or the like, in embodiments this may mean only the whole image is prevented from being transferred, or more preferably in embodiments it may mean that any part of the image content is prevented from being transferred. For example if the watermark is detected over multiple frames such that the image in question is a video image, where it is said that the image is prevented from being stored, transferred, displayed or the like, this preferably means that no individual frame of the video is allowed to be stored, transferred, and/or displayed (in accordance with privacy policy). E.g. so sharing or publishing a still of a video image may be considered one form of sharing or publication of the video image.

There are a number of ways of implementing the privacy database 24. In embodiments, the privacy database may support only a yes/no decision as to whether a scene is protected. In this case the privacy filter 22 is configured with a fixed privacy policy, e.g. blocking one or more of the above actions, which it either applies or does not apply in dependence on whether the watermarked scene is protected in the privacy database 24 or not. In one implementation, the privacy database 24 only registers the watermarks of those scenes that are protected, not those that are unprotected. In this case the privacy filter 22 looks up the detected watermark to determine whether or not an entry for that watermark exists in the database 24. If no entry is found, the respective scene 4 is not privacy protected and the privacy filter 22 does not apply any privacy policy, but if the watermark is found in the database 24 then the privacy filter 22 does apply its privacy policy to the image of the scene 4 in question (e.g. blocks whichever of the above actions or combination of the above actions the privacy filter 22 is preconfigured to block for protected scenes). It would also be possible to implement the database the other way around, such that only unprotected scenes are recorded in the privacy database 24 and images are treated as protected by default unless found in the privacy database 24.

In an alternative implementation, the privacy database 24 maps a respective privacy setting to each of at least some of the watermarks for the different respective locations. In this case, the privacy filter 22 is configured to access the database 24 (locally or remotely), to look up the associated privacy setting mapped to the detected watermark, and to inhibit or enable one or more uses of the captured image in dependence on the associated privacy setting. The privacy setting may specify whether or not the respective watermarked scene 4 is privacy protected. I.e. unlike the above option, the database explicitly states one way or the other if the scene is protected or unprotected. In this case, the privacy filter 22 is configured to look up the respective setting mapped to the detected watermark in the privacy database 24, and to either apply a privacy policy or not depending on whether the respective setting classifies the respective scene 4 as privacy protected or unprotected.

Alternatively or additionally, each privacy setting in the database 24 may be selected from amongst two or more different privacy protected levels. For example the available settings could comprise: no protection, low privacy, medium privacy, and high privacy. Or the settings could just be: low privacy, medium privacy and high privacy, with an image being treated as unprotected if no entry for the detected watermark is found to exist in the database. Some or all of the different levels may correspond to different actions or combinations of actions being blocked; and/or some or all of the different levels may correspond to different users, devices or destinations that are authorized to use the image or authorized to perform certain actions in relation to the image. For example, a high privacy level may disallow the image from being stored, viewed or transferred, such that it must be immediately deleted by the device 6, 12, 16 upon capture or receipt; while a medium image may allow the image to be stored and viewed locally, but only transferred externally by and/or to certain authorized users; and a low privacy level may allow most uses including transfer between individual devices, but may disallow the image being published (e.g. via one or more networks or a social media services).

There are a number of possible applications of the techniques disclosed herein. One exemplary application is to prevent illegal, unauthorized or unwanted video recordings and/or photographs from being recorded, in home and/or professional settings, and in public and/or private spaces. For example an instance of the image handling module 18 implemented in a video camera, smartphone or tablet may be configured to directly prevent video recordings and/or photographs of any scene illuminated by appropriately watermarked light. This would involve an agreement with manufactures of user devices 6, 12 and/or producers of the operating systems of user devices, to include an instance of the image handling module 18 in their products so that all readily-available user devices on the market will respect the privacy policy or policies associated with the watermarks appearing in captured images.

For example, the disclosed techniques may be used to avoid illegal video recordings and/or photographs during live performances of music or theatre plays, avoid Paparazzi video recordings and/or photographs, avoid illegal recordings and/or photographs in museums, avoid unwanted video recordings and/or photographs in schools or other public areas, and/or avoid unwanted video recordings and/or photographs in any other setting. E.g. in Sweden, secretly shooting videos and photos in private settings has been criminalized.

Another exemplary application of the techniques disclosed herein is to prevent images being uploaded to the Internet. Privacy concerns are growing as a result of the increasing use of social media and search engines. The amount of video recordings uploaded to the internet is exponentially growing. Currently, hundreds of hours of video are uploaded to media sharing sites every minute, and billions of hours of video are watched each month of the order of an hour for every person on Earth. Hence in embodiments, the image handling module 18 may be used by internet providers, search engines and/or operators of social media services to determine whether a particular video recording or photograph is allowed to be uploaded to the internet or published via the internet. This would involve agreements with internet providers, providers of search engines and/or providers of social media services, to include an instance of the image handling module 18 on their respective servers 16 so that video recordings and/or photographs including a particular watermark will automatically be blocked from publication on the Internet via that server.

Note, with regard to the implementation of the database 24, as mentioned previously this may be implemented remotely on a separate server which the privacy filter 22 accesses over a network (e.g. the Internet 14), or may be implemented locally on the same device 6, 12 or 16 as the privacy filter 12. In embodiments, if accessed remotely over a network, there is a possibility that sometimes the database 24 will not be available to the privacy filter if access via the network fails. To account for this, in embodiments, the privacy filter may default to treating any watermarked image as private (e.g. the maximum privacy level if different privacy levels are supported) in event that the database 24 cannot be accessed. I.e. the captured image is treated as private or most private unless permission can be obtained that it is not private or has a lesser degree of privacy. Alternatively or additionally, the database 24 (or a copy of it) could be implemented locally on the same device 6, 12, 16 as the privacy filter, thus obviating the risk that it is not accessible due to network issues. For instance, if the privacy filter 22 is implemented on the camera device 6, it may at intervals (e.g. periodically) check for updates to the database 24 and download a copy of any updates to its local storage 10 (or similarly if the privacy filter 22 is implemented on an external device 12 or server 16 of a social media service or the like), or such updates could be pushed to the device 6, 12, 16.

In embodiments the privacy database 24 may be a dedicated privacy database that maps privacy settings directly to watermarks. Alternatively, the privacy database may comprise a constituent location database which maps watermarks to the respective locations of the respective watermarked scenes, and a second constituent database mapping locations to privacy settings. E.g. the location may be defined in the database in terms of geographic coordinates of a central or representative point in or near the scene 4, or a set of coordinates bounding the scene, a postal address, and/or a place name. This may allow a user to specify a privacy request in terms of location, rather than needing to specify the watermark code. And/or, this may allow the database to also be used for one or more additional location-based functions other than just inhibiting the recordal, viewing or distribution of images—e.g. such as tracking the user taking the image.

In embodiments, the privacy settings in the privacy database 24 may also be set as a function of time. I.e. so the scene 4 at a certain location can be defined as privacy protected during certain hours of the day, and unprotected at other times of day. Or the scene 4 may be given different levels privacy protection at different times of day.

In embodiments, the watermark signal may also contain an indication of the current time and/or information on the geographical location of the illuminated. For instance, this would enable the possibility of detecting the relative camera orientation.

In further embodiments, the controller 3 may be configured to adapt the coded light signal- to-noise ratio (SNR) in dependence a detected ambient light level in the environment of the scene 4, to increase the SNR under higher ambient light conditions. The ambient light level can either be detected by an external ambient light sensor unit coupled to the controller 3 as part of a lighting system, or by an embedded ambient light sensor incorporated in a luminaire in which the light source 2 is housed. The detected information on the ambient level may be provided to the controller 3 via a network to which the controller 3 is connected, such as a lighting network comprising the light source 2 and one or more other light sources and/or one or more external light sensors. For example, the controller 3 may be integrated into a same luminaire as the light source 2, and the lighting network may comprise one or more other such luminaires and/or one or more external light sensors. To increase the SNR, the controller 3 may for example: increase the amplitude of the signal, reduce the signal frequency, or repeat the signal multiple times.

Another option is the change of the color of the signal depending on the ambient light level color.

In further embodiments, the system further comprises a payment infrastructure 26 configured to accept payments for the watermark at a desired location to be registered in the privacy database 24. Revenues can then be generated by offering paying customers privacy in respect of certain watermarks or certain locations. E.g. the customer can pay such that each digital photo or recording that has identical location and time as the protected virtual space around the customer can be forbidden for uploading, or even destroyed. Optionally, a service may also be offered allowing the location and/or timeline of the taking photos or making video recordings to be traced. E.g. it can be determined from the watermark and location database that a photograph or video was taken in a predefined area, such as in or around the customer's own house and private property, and/or in a school, theatre, museum and/or public buildings.

In yet further embodiments, a device 6, 12, 16 with an instance of the image handling module 18 is configured to receive a complementary code, corresponding to the detected watermark. This complementary code is received via a medium other than the embedding of information in visible light captured by the camera 8—e.g. the complementary code may be received in metadata of an image file containing said image (e.g. in a header or side info), or may be received via a side channel (i.e. a communication channel based on a medium other than visible light, preferably a wireless side channel such as Wi-Fi, Bluetooth or an RFID tag).

According to one possibility, the complementary code comprises a code for verifying the authenticity of its corresponding watermark. The privacy filter 22 is configured to then check the received complementary code against the detected watermark, in order to verify whether the watermark is legitimate. If not, the use of the image is automatically inhibited. E.g. the maximum level of privacy is applied by default, or the image is destroyed. For example the watermark may be cryptographically signed, and the complementary code may comprise a public key or certificate for verifying the authenticity of the digital signature.

Alternatively or additionally, the watermark may be embedded in the light in encrypted form. In this case, the complementary code comprises a public key for decrypting the watermark, and privacy filter 22 is configured to use this key to decrypt the detected watermark. If it is unable to decrypt (either because it doesn't have the key or the key is wrong), again the use of the image is automatically inhibited, e.g. the maximum level of privacy is applied by default, or the image is destroyed.

By analogy with existing digital rights management (DRM) terminology, such a code or key may be referred to as being part of a digital license. A digital license provides the user (directly or indirectly) with the right and possibility to use a content item. DRM systems tend to use encryption to block access to content, so the license generally contains the required key, or data required to get access to a key.

In the case where the complementary code is inserted into metadata of the image file, this may be added to the file by the camera device 6. If another, external device 12, 16 then receives a copy of the image, its own privacy filter 22 can then check the watermark against the metadata code to determine whether the image appears to have been tampered with between capture by the camera 6 and receipt by the external device 12, 16. This will help prevent malicious parties abusing the watermark system.

In embodiments, the metadata of the photo or video file also indicates if the watermark has been detected or not.

In the case where the complementary code is transmitted via a side channel, this may be implemented in a number of ways. For example, a transmitter may be disposed in the vicinity of a scene 4 configured to transmit the complementary code based on a local (short-range) RF technology, such as Wi-Fi or Bluetooth, or a near-field communication (NFC) technology (e.g. an RF tag). When the camera 8 captures an image of the scene 4 including the watermark embedded in the light illuminating that scene 4, the camera device 6 also receives the complementary code via the side channel. E.g. it receives it wirelessly via the Wi-Fi or Bluetooth side channel, or the user swipes the camera device 6 against the RF tag. The privacy filter 22 in the camera device 6 then checks whether the received complementary code matches the detected watermark. This can help prevent malicious parties from interfering with the privacy of a location by introducing spoofed watermarks into a scene.

Optionally, a party may be charged money to receive the complementary code on his or her device 6, 12, such that customers can be charged to be allowed to make video recordings and/or take photographs. This may be an alternative or additional use of the payment infrastructure 26, to accept payment from a customer for the complementary code for a desired location.

In embodiments where multiple different privacy levels are possible, some example applications are as follows.

Highly classified areas: e.g. military area, police and government buildings. Here no photo shooting is allowed at all. So all smartphone cameras are disabled if they detect this unique privacy classification level identifier. Even local storage on the recording device itself is not allowed.

Company and/or industrial areas: also here the shooting photos in not allowed. However, occasionally smartphones are used distribute white board notes of a meeting to attendees, etc. Again a special authorization is required. Optionally a copy is sent to the boss for authorization.

Museums and churches: the default situation is that recording is not allowed in these buildings. However, an access key can be purchased in some places. With this key private storage is allowed. Sharing with friends on internet may also be allowed. The required key can be bought (pay per visit) to ensure the photos can be uploaded to the internet afterwards.

VIPs (e.g. pop stars, royals etc.): Of course they need to be recorded. Part of their life is public. However, recording could be controlled.

The press/journalists may obtain special keys or licenses (after paying) to take photos during special occasions (public events, concerts including backstage etc.) and use them for commercial purpose.

The paparazzi may not be authorized to take photos if they have not paid for licenses.

Normal folk are allowed to take personal pictures of pop concerts and public events for private use (e.g. to share via social media), but they do not have authorization to provide official content. All other pictures outside an official schedule are classified private and therefore forbidden to capture.

Private celebrations/parties: photos are private and can only be shared between friends, not any further.

It will be appreciated that the above embodiments have been described only by way of example. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. A computer program may be stored and/or distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A system comprising:
a plurality of light sources each arranged to illuminate a respective scene at a respective geographic location;
one or more controllers arranged to embed a respective watermark signal in the illumination from each of said light sources;
a privacy database; and
a device comprising an image handling module configured to detect the respective watermark signal from an image of one of said scenes captured by a camera, and to look up the detected watermark signal in the privacy database, wherein the privacy database maps a respective privacy setting to each of a plurality of watermark signals embedded in light illuminating respective scenes at different geographic locations, and wherein the image handling module further comprises a privacy filter configured to selectively inhibit use of the image of the respective scene at the geographic location based on the privacy setting.

2. A device comprising an image handling module for protecting an image of a scene captured by a camera, the image handling module comprising:
a watermark detector configured to detect, in association with the image, a watermark signal having been embedded in light illuminating the scene at a respective geographic location; and
a privacy filter configured to look up the detected watermark signal in a privacy database, wherein the privacy database maps a respective privacy setting to each of a plurality of watermark signals embedded in light illuminating respective scenes at different geographic locations, and wherein the privacy filter is further configured to selectively inhibit use of the image of the respective scene at the geographic location based on the privacy setting.

3. The system of claim 1, wherein the watermark detector is configured to detect the watermark signal from the image.

4. The system of claim 1, wherein:
the selective inhibiting comprises inhibiting use of the image on condition that a privacy setting for the detected watermark is found in the privacy database.

5. The system of claim 4, wherein each of the privacy settings in the database specifies one of at least two possible classification levels, comprising an unprotected level defining the scene as having no privacy protection, and at least one privacy protected level defining the scene has having at least a degree of privacy; and wherein said selective inhibiting comprises inhibiting use of the image on condition that the privacy setting for the detected watermark specifies a privacy protected level.

6. The system of claim 4, wherein each of the privacy settings in the database specifies one of two or more possible classification levels, comprising a plurality of privacy protected levels each defining the scene as having a different degree of privacy; and wherein said selective inhibiting comprises inhibiting an extent of the use of said image in accordance with the classification level mapped to the detected watermark.

7. The system of claim 6, wherein at least some of the privacy protected levels correspond to different categories of user being authorized to use the image, and said selective inhibiting comprises preventing at least one type of use of the image by users other than those authorized according to the classification level mapped the detected watermark.

8. The of claim 1, wherein, and said selective inhibiting comprises selectively preventing the device from performing one or more of the following types of use, in dependence on the privacy setting mapped to the detected watermark:
(a) recording the image on any local storage of said device,
(b) sharing the image with any external device,
(c) sharing the image with any external device except one or more authorized devices,
(d) sharing the image with one or more prohibited devices,
(e) sharing the image with any external device except one or more devices of one or more authorized users,
(f) sharing the image with one or more external devices of one or more prohibited users,
(g) sending the image over any network,
(h) sending the image over any network except one or more authorized networks,
(i) sending the image over one or more prohibited networks
(j) sending the image to any network address other than one or more authorized addresses,
(k) sending the image to one or more prohibited network addresses,
(l) sending the image over the Internet,
(m) publishing the image over the Internet,
(n) uploading the image to any website,
(o) uploading the image to any website except one or more authorized websites,
(p) uploading the image to one or more prohibited websites,
(q) uploading the image to any social media service,
(r) uploading the image to any social media site except one or more authorized social media services,
(s) uploading the image to one or more prohibited social media services,
(t) accepting the image from any external device,
(u) accepting the image from any external device except one or more authorized devices,
(v) accepting the image from one or more prohibited devices,
(w) accepting the image from the camera,
(x) displaying the image,
(y) making any copy of the image, and/or
(z) publishing the image.

9. The system of claim 8, wherein at least some of the privacy protected levels specify different combinations of which of (a) to (z) are to be prevented.

10. The system of claim 9, wherein at least some of the privacy protected levels specify different combinations of which of (a) to (z) are to be prevented for different categories of user.

11. The system of claim 1, wherein the device comprises said camera incorporated into a same unit as said image handling module.

12. The system of claim 1, wherein the device is:
a user device implemented in a unit separate from said camera, the user device comprising an interface for receiving the image from the camera; or
a server comprising one or more server units at one or more sites, and being separate from the camera, the server comprising a network interface for receiving the image over a network.

13. The system of claim 1, wherein the privacy database comprises a first constituent database mapping the watermark signal to the respective geographic location, and a second constituent database mapping the geographic location to the respective privacy setting.

14. The system of claim 1, wherein at least one of the privacy settings in the database is a function of time.

15. The system of claim 1, wherein the device is configured to receive a complementary code via a medium other than embedding information in light received by the camera; and wherein the privacy filter; is configured to use the complementary code to verify or decrypt the watermark, and to automatically inhibit the use of the image by default if the detected watermark is not successfully verified or decrypted respectively.

16. The system of any of claim 1, further comprising a payment infrastructure arranged to accept a payment in relation to at least one of said geographic locations, and based on said payment to:
enable a party having an interest in the at least one geographic location to pay to register the respective watermark in the privacy database, and/or to select the respective privacy setting of claim 4 or any claim as dependent thereon; or
enable a party wishing to use an image of the at least one geographic location to receive the complementary code.

17. A method for protecting an image of a scene captured by a camera, the method comprising:
detecting, in association with the image, a watermark signal having been embedded in light illuminating the scene at a respective geographic location; and
looking up the detected watermark signal in a privacy database, wherein the privacy database maps a respective privacy setting to each of a plurality of watermark signals embedded in light illuminating respective scenes at different geographic locations, selectively inhibiting use of the image of the respective scene at the geographic location based on the privacy setting.

18. The method of claim 17, further comprising:
illuminating a respective scene at each of a plurality of respective geographic locations; and
embedding a respective watermark signal in the illumination illuminating each of the respective scenes.
wherein said detection comprises detecting the respective watermark signal in association with an image captured by the camera at one of said scenes; and
said lookup is based on the respective watermark.

19. The method of claim 17, further comprising:
keeping the privacy database registering at least some of the watermark signals.

20. The method of claim 18, comprising receiving a payment in relation to at least one of said geographic locations, and in response
allowing a party having an interest in the at least one geographic location to pay to register the respective watermark in the privacy database, and/or to select a respective privacy setting mapped to the respective watermark; or
providing, to a party wishing to use an image, a complementary code for verifying or decrypting the respective watermark.

21. A computer program product stored on a computer-readable medium, comprising program code instructions for implementing a method of claim 17, when said program is loaded and executed on a computer.
